(19) United States
(12) Patent Application Publication
(10) Pub. No.: US 2025/0342826 A1
(43) Pub. Date: Nov. 6, 2025

(54) COMPUTING SYSTEM, METHOD, AND MEDIUM FOR PROCESSING CUSTOMER INQUIRIES USING SPEECH-TO-TEXT, LANGUAGE MODEL ANALYSIS, AND TEXT-TO-SPEECH SERVICES

(71) Applicant: CDW LLC, Vernon Hills, IL (US)

(72) Inventor: Nathan A. Cartwright, Cincinnati, OH (US)

(21) Appl. No.: 18/656,113

(22) Filed: May 6, 2024

(51) Int. Cl. G10L 15/18; G06T 13/40; G10L 13/08; G10L 15/26

(52) U.S. Cl. CPC G10L 15/1815; G06T 13/40; G10L 13/08; G10L 15/26

(57) ABSTRACT

An autonomous communication system includes a language model, a retrieval module, a caching mechanism, an autonomous agent, and a human interface for managing interactions and responses. A method and computer-readable medium for managing communication also include these components for processing, enhancing, summarizing, managing interactions, and allowing human intervention.

### FIELD OF THE INVENTION

The present aspects relate to customer service automation technologies, and more particularly, to systems and methods for processing and responding to customer inquiries using artificial intelligence, such as employing retrieval-augmented generation to enhance responses with information retrieved from various data sources.

### BACKGROUND

In the realm of customer service and support, the evolution of contact centers has been a focal point of technological advancement. Traditionally, these centers have relied heavily on human agents to manage customer interactions, which can vary from simple inquiries to complex problem-solving tasks. This reliance often results in significant operational costs and variability in the quality of service due to factors such as agent skill levels, availability, and workload. Furthermore, the increasing volume of customer interactions across multiple channels, including voice and digital platforms, has placed additional strain on these traditional systems. The challenges are compounded by the need for contact centers to provide 24/7 service, manage fluctuating demand, and ensure customer satisfaction in a competitive marketplace.

Moreover, the integration of artificial intelligence (AI) and machine learning technologies into contact centers has introduced new capabilities but also highlighted limitations in current implementations. These technologies have the potential to automate interactions, provide personalized customer experiences, and enhance decision-making through data analytics. However, the effectiveness of AI-driven solutions is often limited by their ability to understand and process natural language accurately, adapt to new or complex inquiries, and seamlessly escalate issues to human agents when necessary. Additionally, the integration of sentiment analysis and customer feedback mechanisms presents ongoing challenges in accurately gauging customer emotions and satisfaction levels. These limitations underscore the need for continual innovation in AI and machine learning models, including Large Language Models (LLMs), to address the evolving demands of contact center operations. There are therefore opportunities for improved platforms and technologies for solving the identified conventional problems.

### BRIEF SUMMARY OF THE INVENTION

In one aspect, an autonomous communication system includes: (1) a language model configured to process and generate responses to user inputs; (2) a retrieval augmented generation (RAG) module configured to enhance the language model's response generation by retrieving relevant information from a knowledge base; (3) a semantic caching mechanism configured to summarize and store key aspects of interactions for future reference by the language model; (4) an autonomous agent configured to manage and direct user interactions based on processed inputs and generated responses; and (5) a human in the loop interface configured to allow human intervention in the autonomous agent's processing of user interactions when necessary.

In another aspect, a computer-implemented method for managing autonomous communication includes: (1) processing user inputs using a language model; (2) enhancing response generation to the user inputs by retrieving relevant information from a knowledge base using a retrieval augmented generation (RAG) module; (3) summarizing and storing key aspects of interactions using a semantic caching mechanism for future reference by the language model; (4) managing and directing user interactions based on the processed inputs and generated responses through an autonomous agent; and (5) allowing human intervention in the processing of user interactions when necessary via a human in the loop interface.

In yet another aspect, a computer-readable medium includes instructions that when executed cause a computer to: (1) process user inputs using a language model; (2) enhance response generation to the user inputs by retrieving relevant information from a knowledge base using a retrieval augmented generation (RAG) module; (3) summarize and store key aspects of interactions using a semantic caching mechanism for future reference by the language model; (4) manage and direct user interactions based on processed inputs and generated responses through an autonomous agent; and (5) allow for human intervention in the processing of user interactions when necessary via a human in the loop interface.

### BRIEF DESCRIPTION OF THE DRAWINGS

FIG. 1 depicts a computing environment for an autonomous contact center system designed to automate customer interactions and optimize resource allocation using language models (e.g., large language models (LLMs)) and advanced artificial intelligence (AI) techniques according to some aspects.

FIG. 2 depicts a computer-implemented method for automating customer interactions in a contact center using language models and advanced AI techniques to enhance customer experience and optimize resource allocation according to some aspects.

FIG. 3 depicts a computer-implemented data flow diagram for automating customer interactions in a contact center using language models and advanced AI techniques, according to some aspects.

FIG. 4 depicts a computer-implemented data flow diagram for automating customer interactions in a contact center using language models and advanced AI techniques, according to some aspects.

FIG. 5 depicts a computer-implemented method for performing agent/function calling, according to some aspects.

FIG. 6 illustrates a computer-implemented method for managing autonomous communication, designed to enhance user interaction through intelligent processing and response generation.

### DETAILED DESCRIPTION

The detailed description that follows outlines a comprehensive computing system designed to enhance customer service interactions through advanced technological means. This system integrates a variety of components and methodologies to address and improve upon several aspects of computer processing, network usage, and memory utilization, thereby offering a more efficient and user-friendly experience in customer service environments.

The computing system includes a processor and memory that work in tandem to execute computer-executable instructions. These instructions enable the system to receive customer inquiries through voice or chat interfaces. Upon receiving these inquiries, the system employs speech-to-text services to convert the inquiries into text format. This conversion allows for the subsequent analysis of the text to detect the intent behind the inquiries using a language model (e.g., an LLM). Understanding the intent informs the generation of appropriate responses, which are then conveyed back to the customers using text-to-speech services. This seamless integration of speech-to-text and text-to-speech services, underpinned by intent detection through the language model significantly improves processing efficiency by automating the response generation process.

Further enhancing the system's capabilities is the employment of retrieval-augmented generation (RAG). This feature allows the system to enrich responses with information retrieved from various data sources. By leveraging external data, the system can provide more comprehensive and contextually relevant responses, thereby improving the quality of customer interactions. This approach not only optimizes network usage by intelligently sourcing information as needed but also ensures that responses are both accurate and informative.

Another notable improvement is in memory usage, achieved through the storage of transcripts of successful interactions in a memory vector database. This database serves as a valuable resource for refining the system's response mechanisms over time. By analyzing past interactions, the system can identify patterns and preferences, leading to more personalized and effective customer engagements. Additionally, the real-time analysis of customer sentiment and the capability to escalate interactions to human agents based on sentiment thresholds further demonstrate the system's adaptability and sensitivity to customer needs.

The introduction of an interactive avatar for customer engagement enables a more engaging and human-like interaction experience. By employing lip-syncing and animation techniques, the avatar offers realistic expressions that can greatly enhance the quality of customer service. This feature not only improves the user experience but also showcases the system's advanced capabilities in processing and rendering complex animations in real-time.

Moreover, the system's inclusivity and flexibility are evident in its provision for customers to opt-out of AI interaction and request human assistance at any time. This feature ensures that customers retain control over their interaction experience, catering to a wide range of preferences and needs. Additionally, the system's ability to perform real-time translation between languages during customer interactions further underscores its versatility and commitment to accessibility, making it a valuable tool in global customer service environments.

In summary, this computing system introduces several improvements to computer processing, network usage, and memory utilization. By automating the conversion of inquiries into text, intelligently generating responses based on detected intent, and enhancing responses with externally retrieved information, the system offers a more efficient and effective solution for customer service interactions. The storage of interaction transcripts for future analysis, coupled with the deployment of an interactive avatar and the provision for real-time translation, further enhances the system's capabilities, making it a comprehensive solution for modern customer service challenges.

In some aspects, the system may include an AI-driven agent, which is enhanced by a custom-tuned language model. This agent is capable of engaging customers across various channels, including voice and interactive avatars, and employs retrieval-augmented generation (RAG) for providing comprehensive answers. Additionally, the system incorporates sentiment analysis and an opt-out mechanism to ensure customer satisfaction, while a memory vector database stores successful interactions for continual model refinement.

One of the improvements this solution brings to computers is the enhancement of processing capabilities. By leveraging LLMs and AI, the system can process and understand customer queries in real-time, providing accurate and personalized responses. This not only improves the efficiency of the contact center but also significantly reduces the response time to customer inquiries, leading to a more satisfactory customer experience.

By escalating complex interactions to human agents when necessary, the system ensures that network resources are utilized in the most efficient manner. This intelligent allocation of network resources helps in managing the contact center's workload effectively, ensuring that human agents are only engaged when absolutely necessary.

Furthermore, the solution introduces an improvement in memory usage through the implementation of a memory vector database. This database stores transcripts of successful interactions, which the system can retrieve to enhance response quality over time. This not only contributes to the continuous learning and improvement of the AI agent but also optimizes memory usage by ensuring that only relevant and useful data is stored and utilized for model fine-tuning.

The present techniques may include an autonomous agent capable of handling customer interactions with the flexibility to escalate issues to a human if necessary. This agent is designed to utilize language models for technology classification and decision-making processes, including whether to employ a specific tool, consult another agent, or escalate the matter to a human operator. A feature of this agent is its ability to continuously learn and improve its performance through human-in-the-loop training and the use of semantic memory, which aids in tracking conversations and recalling previous resolutions.

The agent may be equipped to handle customer interactions via voice or text, featuring an avatar component that represents the agent during these interactions. This allows customers to engage with a character of their choice, enhancing the user experience. The agent may use retrieval augmented generation from the onset of customer interaction, enabling it to autonomously determine the appropriate tools or knowledge sources to address inquiries without the need for explicit intent mapping.

For training and data storage, the agent's model may be continuously refined using conversation transcripts. However, to optimize storage, a summarization pipeline may be utilized to create semantic caches of conversation summaries, which serve as a reference for future interactions and training purposes.

The agent may operate within a framework that supports the use of external knowledge sources and larger language models for reasoning. This includes the implementation of a MRKL function for reasoning and function calling, allowing the agent to select the most suitable tool or API based on user input. The agent is also capable of collaborating with specialized agents for specific tasks, leveraging techniques such as semantic caching, autonomous decision-making, and human-in-the-loop interventions.

Overall, this autonomous contact center solution enables the use of AI and language models to automate and improve customer service operations. By enhancing processing capabilities, optimizing network and memory usage, and continuously learning from interactions, this system offers a scalable, efficient, and highly effective approach to managing customer interactions in a variety of domains.

### Computing Environment

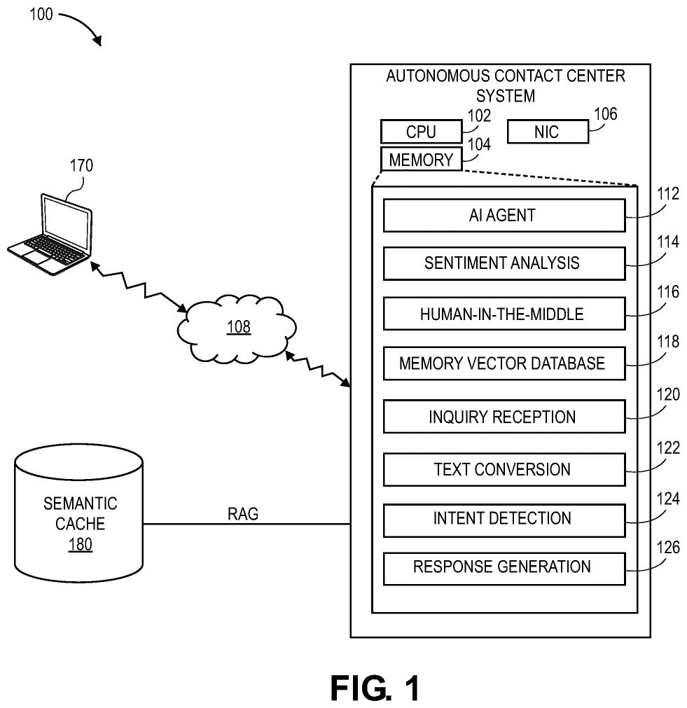

FIG. 1 depicts an exemplary computing environment 100 for an autonomous contact center system integrates advanced artificial intelligence (AI) technologies, including language models (e.g., Large Language Models (LLMs)) to automate customer interactions, optimize resource allocation, and enhance the overall customer experience. The computing environment 100 is designed to handle both text-based and voice interactions with high fluency, employing retrieval-augmented generation (RAG) for comprehensive response generation and sentiment analysis for real-time customer sentiment monitoring.

The computing environment 100 includes a processor 102. The processor 102 may include one or more CPUs, one or more GPUs, etc. The processor 102 executes computer-executable instructions (for example, instructions for various operations of an autonomous contact center, including interaction with customers through an AI-driven agent, sentiment analysis, communication with human agents, etc.).

The computing environment 100 also includes a memory 104. The memory 104 may include a random-access memory (RAM), a read-only memory (ROM), a hard disk drive (HDD), a magnetic storage, a flash memory, a solid-state drive (SSD), and/or one or more other suitable types of volatile or non-volatile memory. The memory 104 stores computer-executable instructions that the processor 102 executes. Within the memory 104, there are several modules, each responsible for a specific function of the autonomous contact center system. These modules include a language (LM) model-powered AI agent module 112, a sentiment analysis module 114, a human-in-the-middle escalation module 116, and a memory vector database module 118.

The LM-powered AI agent module 112 contains instructions for engaging customers through text-based and voice interactions. It utilizes retrieval-augmented generation to enhance the quality of responses by incorporating information from various data sources. The sentiment analysis module 114 monitors real-time customer sentiment through speech and text analysis, triggering escalation to human agents based on predefined sentiment thresholds. The human-in-the-middle escalation module 116 facilitates seamless intervention by human agents for complex queries or issues beyond the AI agent's capabilities. The memory vector database module 118 stores transcripts of successful interactions, supporting continual refinement of the AI agent's responses.

In some aspects, the memory 104 stores additional modules, such as an inquiry reception module 120, a text conversion module 122, an intent detection module 124, and a response generation module 126.

The inquiry reception module 120 is responsible for receiving customer inquiries via voice or chat. This module works in conjunction with the processor 102 to ensure that all incoming inquiries are captured and ready for further processing. The text conversion module 122 converts the received inquiries into text using speech-to-text services. This conversion enables the subsequent analysis of the text to detect the intent of the inquiries. The intent detection module 124 analyzes the converted text to detect the intent of the inquiries using a large language model (LLM). This module leverages the processor 102 computational capabilities and the advanced AI techniques embedded within the LM to accurately understand the customer's needs. The response generation module 126 generates responses to the inquiries based on the detected intent using text-to-speech services. This module ensures that the system can communicate effectively with customers, providing them with the information or assistance they seek.

Additionally, the computing environment 100 includes a network interface controller (NIC) 106, enabling communication with external data sources, customer interfaces, and other systems necessary for the autonomous contact center's operation. The NIC 106 enables the computing environment 100 to access other devices (e.g., a client computing device 170, a database 180, etc.) via an electronic network 108. The network 108 may include the Internet and/or another suitable network (e.g., a local area network (LAN), a metropolitan area network (MAN), a wide area network (WAN), a mobile, a wired or wireless network, a virtual private network (VPN), etc.).

The database 170 may encompass various types and forms of data storage systems, including but not limited to relational databases, NoSQL databases, in-memory databases, cloud databases, distributed databases, object-oriented databases, graph databases, and time-series databases. Examples of relational databases include MySQL, PostgreSQL, Oracle Database, and Microsoft SQL Server, which are designed for structured data storage and support SQL for data manipulation. NoSQL databases, such as MongoDB, Cassandra, Couchbase, and DynamoDB, cater to unstructured or semi-structured data, offering flexibility in data models and scalability. In-memory databases like Redis and Memcached provide high-performance data access by storing data in the main memory. Cloud databases, including Amazon RDS, Google Cloud SQL, and Microsoft Azure SQL Database, offer database services hosted in the cloud, ensuring scalability, high availability, and managed services. Distributed databases, such as CockroachDB and Google Spanner, are designed to run across multiple nodes or locations, ensuring data consistency and fault tolerance. Object-oriented databases, for instance, ObjectDB and db40, store data in the form of objects, as used in object-oriented programming. Graph databases, like Neo4j and Amazon Neptune, are optimized for storing and querying data that is interconnected, making them ideal for social networks, recommendation engines, and fraud detection. Time-series databases, such as InfluxDB and TimescaleDB, are specialized for handling time-stamped or time-series data, widely used in financial services, IoT, and monitoring systems. Each of these databases offers unique features and capabilities tailored to specific data storage, management, and retrieval needs, enabling efficient and effective handling of diverse data types and volumes across various applications and industries.

The client device 180 may encompass a wide array of computing devices that individuals use to interact with an automated call center system. These devices include, but are not limited to, smartphones, tablets, desktop computers, laptop computers, smartwatches, smart speakers, and virtual reality (VR) headsets. Smartphones, such as iPhones, Android phones, and Windows phones, offer a portable means to access call center services through voice commands, dedicated apps, or web interfaces. Tablets, including iPads, Android tablets, and Microsoft Surface devices, provide a larger screen for an enhanced visual interface while retaining portability, making them ideal for navigating complex customer service portals or engaging in video chats with service representatives. Desktop computers, encompassing various models from manufacturers like Dell, HP, Lenovo, and Apple, offer robust processing power and a stable platform for accessing web-based call center systems, often preferred in office or home office settings. Laptop computers, including MacBooks, Ultrabooks, and Chromebooks, combine the power of desktops with the portability of smaller devices, allowing users to access call center services from virtually anywhere. Smartwatches, such as the Apple Watch, Samsung Galaxy Watch, and Fitbit, extend the functionality of smartphones to the wrist, enabling users to receive notifications or initiate simple commands related to call center services directly from their watch. Smart speakers, including Amazon Echo, Google Home, and Apple HomePod, leverage voice recognition technology to allow hands-free interaction with call center systems, making it convenient to request information or perform tasks without needing to use a handheld device. Virtual reality (VR) headsets, like the Oculus Rift, HTC Vive, and PlayStation VR, represent a more immersive technology that could be used for virtual meetings or consultations with customer service representatives, offering a 3D virtual environment for complex product demonstrations or detailed service discussions. Each of these client devices offers unique features and capabilities tailored to specific user needs and preferences, enabling convenient and flexible access to automated call center systems across various contexts and scenarios.

In operation, the autonomous contact center system engages with customers through an AI-driven agent, powered by the LLM-powered AI agent module 112. Customers can interact with the system via voice or text, with the system dynamically adjusting responses based on the content and sentiment of the interaction, as analyzed by the sentiment analysis module 114. When the system detects complex queries or dissatisfaction, the human-in-the-middle escalation module 116 ensures smooth escalation to human agents. Throughout this process, the memory vector database module 118 collects data on successful interactions, facilitating continuous improvement of the system's responses and capabilities.

The computing environment 100 may functions as an autonomous contact center system. Customers may interact with the system via voice or chat, and their inquiries may be received and processed by the inquiry reception module 112. These inquiries may then converted into text by the text conversion module 114, allowing the intent detection module 116 to analyze the text and determine the customer's intent. Based on this analysis, the response generation module 118 may craft and delivers appropriate responses to the customers, completing the interaction loop.

This autonomous system significantly enhances the customer experience by providing fast, accurate, and personalized responses. It also optimizes resource allocation within the contact center by automating routine inquiries, freeing human agents to focus on more complex cases. The system's ability to learn from interactions, supported by the continual refinement of the LM and the modules within the memory 104, ensures that its performance improves over time, making it an increasingly valuable asset for any contact center. This computing environment exemplifies how an autonomous contact center can leverage AI and LLM technologies to provide efficient, personalized customer service while maintaining the flexibility to escalate to human agents as needed.

The language model-powered AI agent module 112 engages customers through both text-based and voice interactions, utilizing advanced AI techniques to understand and respond to customer inquiries. For example, a business user may interact with the system via a chat interface to get quick answers about service offerings, while a visually impaired user might use voice commands to navigate through the system's options.

The sentiment analysis module 114 monitors and analyzes the tone and sentiment of the customer's speech or text in real-time. For instance, a frustrated customer raising their voice during a call would trigger this module to assess the sentiment as negative, potentially escalating the call to a human agent.

The human-in-the-middle escalation module 116 intervenes when the AI agent encounters queries or issues that exceed its processing capabilities, ensuring that customers are seamlessly transferred to human agents for further assistance. This could happen if a customer asks for a detailed explanation of billing discrepancies that the AI cannot compute accurately.

The memory vector database module 118 stores and retrieves transcripts of successful interactions, which aids in the continuous improvement of the AI agent's responses. For example, when a customer inquires about the process for returning a product, the system can pull similar successful interactions to guide its response. The memory vector database module 118 stores the information in a semantic cache, where interactions are indexed based on key concepts and relationships rather than just keywords. For instance, a successful interaction about a product return due to a defect might be semantically linked to quality assurance processes. An asynchronous training process then performs additional training on the AI models using this semantically rich data, enhancing the system's understanding and response capabilities. Once the training is complete, the semantic cache is cleared to make room for new interactions, ensuring the system continuously evolves and improves.

The inquiry reception module 120 receives customer inquiries through various channels such as voice calls or chat messages, ensuring that every customer's request is captured for processing. A customer using a mobile app to send a chat message about account issues would have their inquiry captured by this module.

The text conversion module 122 converts all received inquiries into text, enabling the system to analyze and understand the customer's request. For instance, a voice call from a customer asking to change a hotel reservation is converted into text for further processing.

The intent detection module 124 analyzes the text to understand the customer's intent using advanced language models. This module would detect that the customer's intent is to change an existing hotel reservation.

The response generation module 126 generates appropriate responses based on the detected intent, converting the response back into speech if necessary. This ensures that the customer receives a coherent and relevant answer to their inquiry.

For example, when a call is made to change an existing hotel reservation, the process may work as follows:

The inquiry reception module 120 captures the incoming voice call. Next, the text conversion module 122 converts the voice inquiry into text for analysis. The intent detection module 124 then analyzes the converted text to understand that the customer's intent is to change a hotel reservation. The language model-powered AI agent module 112 retrieves the customer's reservation details from the database and confirms the possibility of changes based on availability. If the customer also inquires about the hotel's pet policy, which is not available in the system's database, the sentiment analysis module 114 detects the customer's need for additional information, and the human-in-the-middle escalation module 116 seamlessly transfers the call to a human agent to answer the question about pet policies. Once the human agent provides the necessary information, the response is captured by the memory vector database module 118 for future reference. Finally, the response generation module 126 communicates the updated reservation details and the pet policy information back to the customer, completing the interaction.

### Computer-Implemented Method

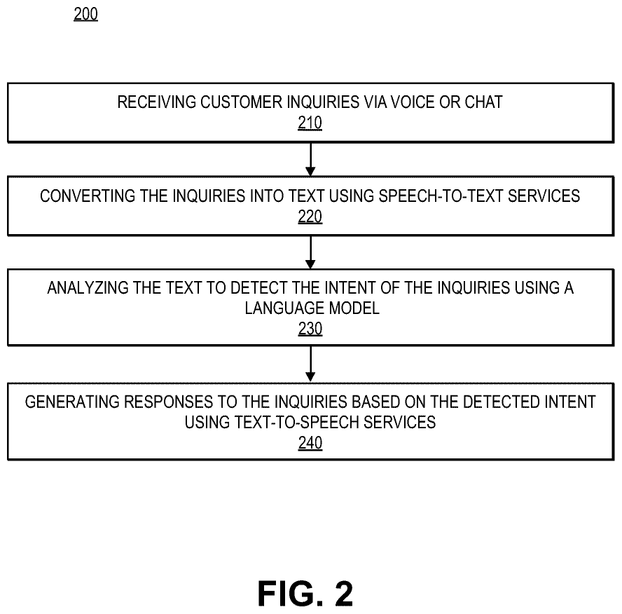

FIG. 2 depicts a computer-implemented method 200 for automating customer interactions in a contact center environment using Large Language Models (LLMs) and advanced AI techniques. This method aims to optimize resource allocation, enhance customer experience, and provide a seamless transition between AI-driven interactions and human agent interventions when necessary. The method 200 is designed to be implemented in a computing environment that includes a custom-tuned LM, retrieval-augmented generation (RAG) capabilities, sentiment analysis tools, a memory vector database, and an interactive avatar for visual engagement, among other components.

The method 200 is designed to automate customer interactions, optimize resource allocation, and enhance customer experience through a seamless integration of various technologies. The method 200 may be executed within the computing environment 100 in some aspects.

The method 200 may include receiving a customer interaction request through a voice channel or via an interactive avatar (block 202). This step involves the AI-driven agent, powered by a custom-tuned LM, engaging with customers. The computing environment for this step includes the integration of voice recognition and text-to-speech technologies to handle both voice and text-based interactions. The interactive avatar, equipped with lip-syncing and animation techniques, provides a visual interface for enhanced customer engagement. This step involves the initial interaction with the customer, where the system captures the customer's inquiry through either voice communication or chat messages. The computing environment is equipped to handle both text-based and voice interactions fluently, ensuring a wide range of customer preferences are accommodated.

For voice inquiries, this step may involve the use of advanced speech-to-text services that accurately transcribe spoken words into written text. This conversion enables the subsequent analysis of the inquiry's intent and ensures that voice interactions are seamlessly integrated into the system's workflow.

Next, the method may include analyzing the customer interaction using retrieval-augmented generation (RAG) to provide comprehensive answers based on information from various data sources (block 204). The RAG module integrates with the LM to enhance the Al agent's responses by retrieving relevant information from a knowledge base, a memory vector database storing successful interaction transcripts, and external APIs for dynamic information retrieval. This step ensures that the AI agent can provide accurate and contextually relevant responses to customer inquiries. This step may leverage a custom-tuned LM (e.g., an LLM) optimized for contact center domain knowledge. The LM analyzes the text to understand the customer's intent, enabling the system to provide relevant and accurate responses. The integration of retrieval-augmented generation (RAG) further bolsters this step by enhancing answers with information retrieved from various data sources, such as a knowledge base, a memory vector database, and external APIs. Once the intent is understood, the system generates a response that addresses the customer's inquiry. The use of text-to-speech services enables the system to deliver the response in a voice format, providing a natural and engaging interaction experience. This step may also involve the use of an interactive avatar that employs lip-syncing and animation techniques for realistic expression, enhancing customer engagement.

The method may include monitoring customer sentiment in real-time through speech and text analysis (block 206). Sentiment analysis tools assess the customer's emotional state during the interaction. If the sentiment analysis detects frustration or dissatisfaction, indicating negative sentiment thresholds, the system triggers an escalation to a human agent. This step ensures that customers experiencing dissatisfaction with the AI-driven interaction are promptly attended to by human agents, maintaining customer satisfaction.

Additionally, the method may include escalating the interaction to a human agent based on the complexity of the query or the detected sentiment (block 208). The human-in-the-middle (HITM) component facilitates seamless intervention by human agents for answering complex queries or resolving issues beyond the AI agent's current capabilities. This step also includes providing feedback from human agents to improve the LLM and overall agent performance.

The method may further include storing transcripts of successful interactions in a memory vector database (block 210). This database facilitates the retrieval of interaction data by the LLM, enhancing response quality over time. The backend analytics component analyzes completed interactions for quality assurance and identifies positive, self-resolved interactions suitable for model fine-tuning. This continuous learning loop, fueled by interaction data and model fine-tuning, steadily improves the system's competence.

Lastly, the method may include offering a customer opt-out mechanism to request human interaction at any time (block 212). This feature ensures that customers can easily switch to interacting with a human agent if they prefer, enhancing the customer experience by providing flexibility in how interactions are handled.

The computing environment for implementing the method 200 includes a combination of hardware and software components designed to support the functionalities described above. These components work together to automate customer interactions, analyze sentiment, escalate interactions when necessary, and continually refine the system's performance based on interaction data. The integration of these advanced AI and machine learning technologies in a contact center environment represents a significant step forward in automating customer service operations while maintaining high levels of customer satisfaction.

The computing environment that executes the method 200 may be part of an autonomous contact center solution that includes several key components. These components work together to provide a comprehensive and effective system for automating customer interactions. The LLM-powered AI agent is at the core of this solution, handling both text-based and voice interactions with fluency. The interactive avatar offers an optional visual interface for enhanced customer engagement. Real-time sentiment analysis monitors customer sentiment through speech and text analysis, triggering human escalation when necessary. The human-in-the-middle component allows for seamless intervention in complex queries. Backend analytics analyze completed interactions for quality assurance and process optimization, while the memory vector database stores transcripts of successful interactions for continual model refinement.

The present autonomous contact center techniques improve customer service, leveraging the latest advancements in AI and machine learning to automate interactions, optimize resource allocation, and enhance the customer experience. Through the integration of various technologies and the use of a custom-tuned LLM, the system provides a seamless, efficient, and effective solution for handling customer inquiries.

### Exemplary Computer-Implemented Architecture

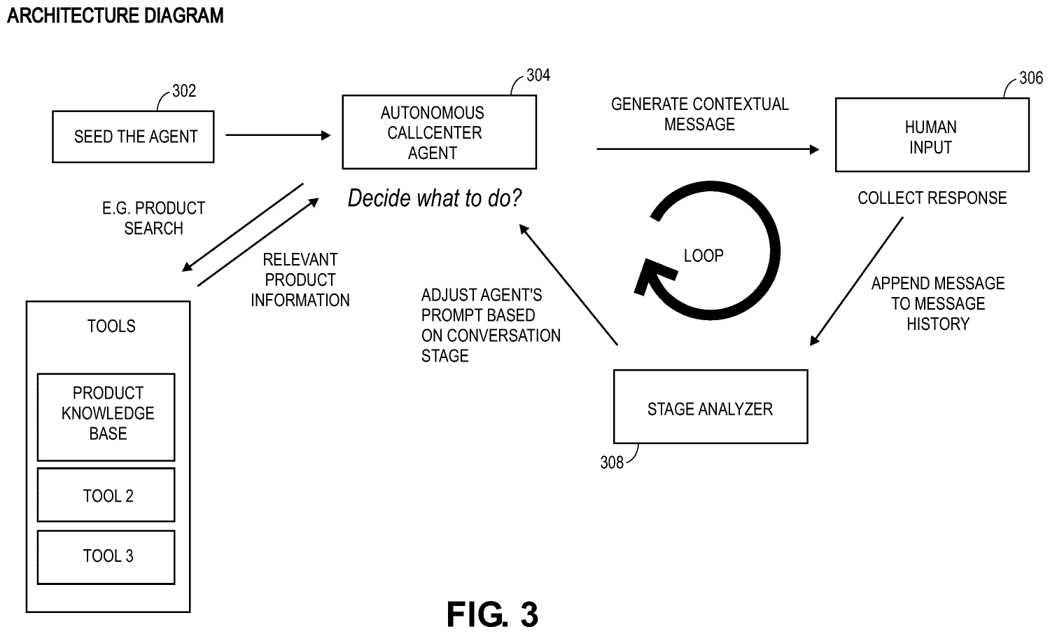

FIG. 3 depicts an exemplary data flow architecture 300 for automating customer interactions in a contact center using language models and advanced AI techniques, according to some aspects.

The data flow architecture 300 illustrates a four-step process for an autonomous contact center agent. The architecture 300 includes seeding the agent (block 302). The architecture 300 provides the agent with initial information, such as call center product information. This information may come from the “Tools” section, which includes a Product Knowledge Base, Tool 2, and Tool 3. The architecture 300 includes determining a next action by processing the initial information by the autonomous agent (block 304). The autonomous call center agent can adjust the agent's prompt based on the conversation stage. After the agent generates a contextual message, it may collect a response from a human (block 306). The architecture 300 may append this response to the message history. The architecture 300 may include a stage analyzer that reviews the conversation stage and feeds back into the loop for the autonomous agent to decide its next action (block 308). The process may be cyclical, as indicated by the loop arrow, meaning that the agent continues to interact with human input, adjust its prompts, and analyze the conversation stage until the process is complete.

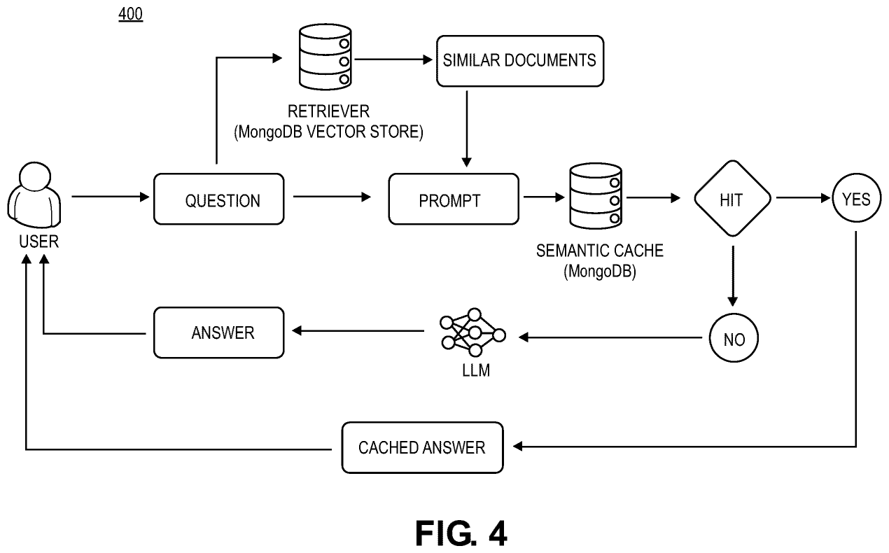

FIG. 4 depicts a computer-implemented data flow architecture 400 for automating customer interactions in a contact center using language models and advanced AI techniques, according to some aspects. In particular, the data flow architecture 400 outlines the flow of processing a question using a language model (LM) augmented with a retriever and semantic cache system. The data flow architecture may receive an input question, which is converted into a prompt (block 402). The data flow architecture 400 may search a vector store for similar documents through a retriever component (block 402). Simultaneously, the data flow architecture 400 may check the prompt against a semantic cache to see if the answer already exists. For example, the semantic cache may be an electronic database such as an SQL database, a NoSQL database, etc. If there is a cache hit, the data flow architecture 400 may return the cached answer immediately. If there is no cache hit, the data flow architecture 400 may pass the question to the LM to generate an answer. Once the answer is obtained, the data flow architecture 400 may send the answer back to the user. The answer may also be cached in the semantic cache for future quick retrieval.

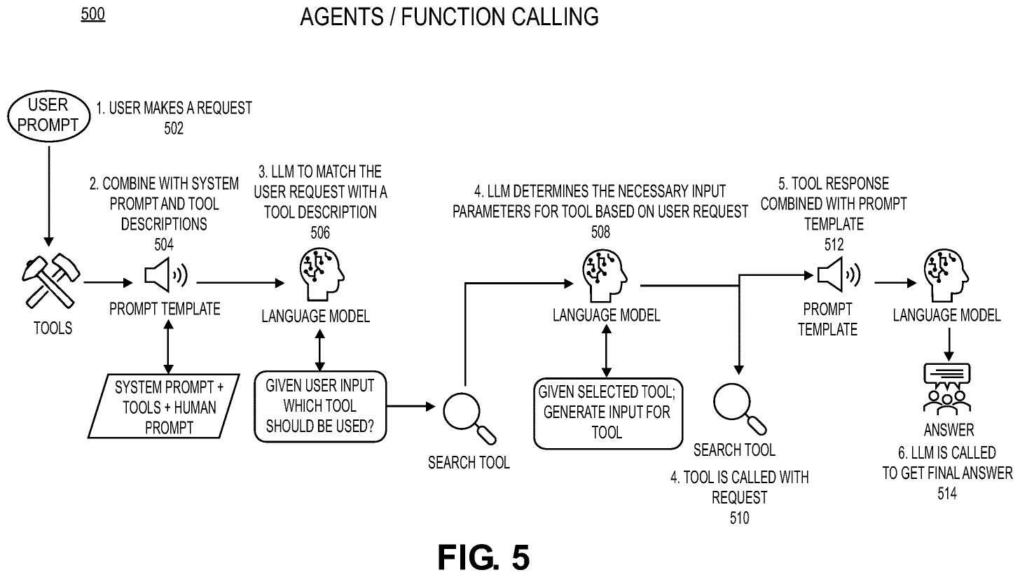

FIG. 5 depicts a computer-implemented method 500 for performing agent/function calling. The method 500 may include receiving a user request (block 502). The method may include combining a system prompt and tool descriptions to create a prompt template (block 504). The method 500 may include matching the user request with a tool description (block 506). The method 500 may include determining necessary input parameters for the tool based on the user request (block 508). The method 500 may include providing the search tool with the user input to generate input for the tool, and calling the tool with the request (block 510). The method 500 may include combining the prompt template with the tool response (block 512), and sending the combination to the LM to generate a final answer (block 514).

### Additional Computer-Implemented Methods

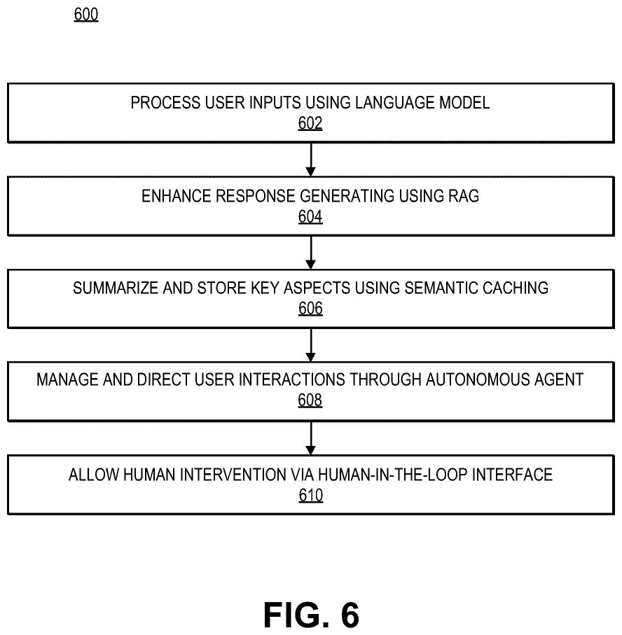

FIG. 6 illustrates a computer-implemented method 600 for managing autonomous communication, designed to enhance user interaction through intelligent processing and response generation. This method leverages a language model, a retrieval augmented generation (RAG) module, semantic caching, and an autonomous agent framework, incorporating human intervention when necessary to ensure high-quality communication. The method 600 facilitates a dynamic and responsive communication environment, capable of handling complex user inputs and generating accurate, contextually relevant responses.

The method 600 begins with processing user inputs using a language model (block 602). This step involves interpreting the user's input to understand the intent and context, enabling the system to generate a coherent and relevant response. The language model is trained on a vast corpus of data, allowing it to comprehend a wide range of inputs and engage in natural, human-like conversations.

Next, the method includes enhancing response generation to the user inputs by retrieving relevant information from a knowledge base using a retrieval augmented generation (RAG) module (block 604). The RAG module supplements the language model's capabilities by pulling in external information that is pertinent to the user's query, thereby improving the accuracy and depth of the responses provided.

The method further comprises summarizing and storing key aspects of interactions using a semantic caching mechanism for future reference by the language model (block 606). This step ensures that the system learns from each interaction, gradually improving its ability to respond to similar queries in the future. The semantic caching mechanism efficiently organizes and stores interaction summaries, making them easily accessible for the language model.

Managing and directing user interactions based on the processed inputs and generated responses through an autonomous agent is another critical step (block 608). The autonomous agent oversees the flow of communication, ensuring that responses are delivered in a timely and appropriate manner. It can direct the conversation, ask clarifying questions, or take specific actions based on the user's inputs and the system's responses.

Allowing human intervention in the processing of user interactions when necessary via a human in the loop interface is also included. This step ensures that users can be escalated to a human operator for issues that require empathy, nuanced understanding, or are beyond the current capabilities of the autonomous system. The human in the loop interface facilitates a seamless transition between automated and human-assisted interactions.

To implement the human in the loop interface in such a way that it avoids actually requiring human input, while still maintaining the option for human intervention when necessary, several technical strategies can be employed. These strategies focus on automating the decision-making process as much as possible, using advanced algorithms and machine learning techniques to minimize the scenarios where human input is needed. For example, in some aspects, the human-in-the-loop implementation may include dynamic thresholds for when to escalate an interaction to a human. These thresholds can be based on the complexity of the request, the confidence level of the autonomous agent in handling the interaction, or the sensitivity of the information being discussed. In some aspects, human input may be simulated.

The method 600 may further include utilizing chain of thought reasoning by the language model to improve the processing of complex user inputs. This approach enables the system to handle multi-step reasoning tasks more effectively, providing more accurate and comprehensive responses to complex queries.

Additionally, the method may involve utilizing external APIs or tools as part of the information retrieval process by the RAG module to enhance response accuracy. This step allows the system to access up-to-date information and specialized knowledge from external sources, further improving the quality of the responses.

Employing a vector database by the semantic caching mechanism for efficient storage and retrieval of interaction summaries is also part of the method. The vector database enables quick and efficient access to stored data, facilitating faster response generation and a more dynamic interaction experience.

The method may include selectively engaging additional specialized agents based on the context of the user interaction by the autonomous agent. Each specialized agent is trained for specific interaction types, allowing the system to handle a wide range of queries with high expertise.

Providing feedback mechanisms for human operators to refine the responses generated by the language model and to update the knowledge base used by the RAG module via the human in the loop interface is another aspect. This feedback loop ensures continuous improvement of the system, enhancing its accuracy and reliability over time.

Lastly, the method comprises utilizing a framework by the autonomous agent for combining external knowledge with the language model to enhance reasoning capabilities during user interactions. This integrated approach allows the system to leverage both its internal knowledge and external information sources, resulting in richer and more contextually appropriate responses.

### Exemplary Computer-Implemented Language Models

Language models are sophisticated software algorithms designed to understand, interpret, and generate human language. These models are trained on vast datasets of text, learning patterns, grammar, context, and nuances of language to simulate human-like responses to textual inputs. Language models can vary significantly in their architecture, capabilities, and applications, ranging from simple models that process and generate text based on predefined rules to complex models that leverage deep learning to understand and produce language in a way that mimics human conversation.

For implementing parts of the present techniques, different types of language models could be utilized, each offering unique advantages depending on the specific requirements of the system, including:
1. Local Language Models: These models are deployed on local servers or devices, offering the advantage of privacy and data security, as all processing is done in-house without the need for external data transmission. Local models might be preferred in environments where data sensitivity is a concern, although they may be limited by the computational resources of the device or server they are deployed on.
2. Cloud-Based Language Models: These models operate on cloud servers, providing the benefit of scalable computational resources, which can be adjusted based on the system's demand. Cloud-based models facilitate access to the latest language model updates and improvements without the need for manual upgrades. However, they require a reliable internet connection and involve considerations around data privacy and security.
3. Multi-Modal Language Models: Multi-modal models are capable of processing and generating responses not just based on text but also other forms of input such as images, audio, and video. This versatility can enhance the autonomous communication system's ability to understand and respond to user inputs more comprehensively, making it suitable for applications requiring interaction beyond text.
4. Large Language Models: These models are characterized by their vast number of parameters, enabling them to understand and generate language with a high degree of sophistication and nuance. Large models can generate more coherent and contextually relevant responses, making them ideal for complex interaction systems. However, they require significant computational resources for training and inference.
5. Small Language Models: Contrary to large models, small language models are designed to be more resource-efficient, requiring less computational power for operation. While they may not match the depth of understanding and response quality of larger models, they are suitable for applications where computational resources are limited or where rapid response times are critical.

For example, the autonomous communication system could leverage these different types of language models in conjunction with Retrieval Augmented Generation (RAG), which enhances response generation by pulling in relevant information from a knowledge base. A semantic caching mechanism would further optimize the system's performance by summarizing and storing key aspects of interactions, allowing the language model to reference these summaries in future interactions. The autonomous agent would manage user interactions, directing the flow based on the language model's processed inputs and generated responses, while a human in the loop interface ensures that human oversight is available when necessary, maintaining the system's reliability and accuracy.

### Exemplary Improvements

The combination of elements in the claims results in significant improvements to computer or other technology, particularly in the field of automated customer service systems. These improvements are achieved through enhanced efficiency, accuracy, and user experience, which are critical in today's fast-paced and globalized business environment.

Receiving customer inquiries via voice or chat and converting them into text using speech-to-text services improves computational efficiency by enabling the system to process inquiries in a uniform text format, regardless of the input method. This uniformity simplifies subsequent processing steps and optimizes the use of computational resources by reducing the need for separate processing pipelines for voice and text inputs.

By employing advanced language models to analyze the text to detect the intent of the inquiries using a language model, the system can understand the context and intent behind customer inquiries with a high degree of accuracy. This reduces the computational load associated with guesswork or multiple rounds of clarification, leading to faster response times and more efficient use of processing power.

Generating responses to the inquiries based on the detected intent using text-to-speech services enhances the system's ability to provide natural and understandable responses, improving the customer experience. The use of text-to-speech services ensures that responses are delivered in a conversational manner, which is less taxing on computational resources than generating complex, pre-recorded audio responses for each possible inquiry.

Employing retrieval-augmented generation (RAG) to enhance responses leverages external data sources to provide more accurate and informative responses. This approach improves the system's utility by enabling it to access and incorporate a wide range of information without the need for extensive internal databases, thus optimizing bandwidth and storage requirements.

Storing transcripts of successful interactions in a memory vector database enhances the system's learning capabilities by creating a repository of successful interactions that can be used for training and improving the language model. The use of a memory vector database optimizes storage efficiency and retrieval speed, which is crucial for real-time learning and adaptation.

Analyzing customer sentiment in real-time and escalating the interaction to a human agent based on sentiment thresholds improves the system's responsiveness to customer needs by ensuring that complex or sensitive issues are handled by human agents. Real-time sentiment analysis allows for the efficient allocation of human resources, focusing them on interactions where they are most needed, thus optimizing the overall system's performance.

Providing an interactive avatar for customer engagement with lip-syncing and animation techniques enhances the user experience by making interactions more engaging and personable. Advanced lip-syncing and animation techniques require sophisticated computational algorithms, but they significantly improve customer satisfaction and engagement without necessarily increasing the overall computational load, thanks to optimizations in graphics processing technologies.

Allowing customers to opt-out of AI interaction and request human assistance at any time ensures flexibility and personalization in customer service, improving user satisfaction. It also allows the system to allocate computational resources more effectively by directing them away from interactions that are better handled by human agents.

Performing real-time translation between languages during customer interactions significantly enhances the system's accessibility and global reach by removing language barriers. Real-time translation requires substantial computational resources for accuracy and speed, but it enables businesses to serve a wider customer base without the need for multilingual staff, thus improving operational efficiency.

In summary, the combination of these elements results in a highly efficient, accurate, and user-friendly automated customer service system. The system makes better use of computational resources by optimizing processing tasks, reducing the need for human intervention, and improving the scalability and accessibility of customer service operations.

### Exemplary Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system comprising: a processor and a memory having stored thereon computer-executable instructions that, when executed, cause the computing system to: receive customer inquiries via voice or chat; convert the inquiries into text using speech-to-text services; analyze the text to detect the intent of the inquiries using a language model; and generate responses to the inquiries based on the detected intent using text-to-speech services.
2. The computing system of aspect 1, further comprising instructions that cause the computing system to employ retrieval-augmented generation (RAG) to enhance the responses with information retrieved from various data sources.
3. The computing system of any of aspects 1-2, further comprising instructions that cause the computing system to store transcripts of successful interactions in a memory vector database.
4. The computing system of any of aspects 1-3, further comprising instructions that cause the computing system to analyze customer sentiment in real-time and escalate the interaction to a human agent based on sentiment thresholds.
5. The computing system of any of aspects 1-4, further comprising instructions that cause the computing system to provide an interactive avatar for customer engagement, the avatar employing lip-syncing and animation techniques for realistic expression.
6. The computing system of any of aspects 1-5, further comprising instructions that cause the computing system to allow customers to opt-out of AI interaction and request human assistance at any time.
7. The computing system of any of aspects 1-6, further comprising instructions that cause the computing system to perform real-time translation between languages during customer interactions.
8. A computer-implemented method comprising: receiving customer inquiries via voice or chat; converting the inquiries into text using speech-to-text services; analyzing the text to detect the intent of the inquiries using a language model; and generating responses to the inquiries based on the detected intent using text-to-speech services.
9. The method of aspect 8, further comprising employing retrieval-augmented generation (RAG) to enhance the responses with information retrieved from various data sources.
10. The method of any of aspects 8-9, further comprising storing transcripts of successful interactions in a memory vector database.
11. The method of any of aspects 8-10, further comprising analyzing customer sentiment in real-time and escalating the interaction to a human agent based on sentiment thresholds.
12. The method of any of aspects 8-11, further comprising providing an interactive avatar for customer engagement, the avatar employing lip-syncing and animation techniques for realistic expression.
13. The method of any of aspects 8-12, further comprising allowing customers to opt-out of AI interaction and request human assistance at any time.
14. The method of any of aspects 8-13, further comprising performing real-time translation between languages during customer interactions.
15. A computer-readable medium having stored thereon instructions that when executed cause a computer to perform: receiving customer inquiries via voice or chat; converting the inquiries into text using speech-to-text services; analyzing the text to detect the intent of the inquiries using a language model; and generating responses to the inquiries based on the detected intent using text-to-speech services.
16. The computer-readable medium of aspect 15, further comprising instructions that cause the computer to employ retrieval-augmented generation (RAG) to enhance the responses with information retrieved from various data sources.
17. The computer-readable medium of any of aspects 15-16, further comprising instructions that cause the computer to store transcripts of successful interactions in a memory vector database.
18. The computer-readable medium of any of aspects 15-17, further comprising instructions that cause the computer to analyze customer sentiment in real-time and escalate the interaction to a human agent based on sentiment thresholds.
19. The computer-readable medium of any of aspects 15-18, further comprising instructions that cause the computer to provide an interactive avatar for customer engagement, the avatar employing lip-syncing and animation techniques for realistic expression.
20. The computer-readable medium of any of aspects 15-19, further comprising instructions that cause the computer to allow customers to opt-out of AI interaction and request human assistance at any time.
21. An autonomous communication system comprising: a language model configured to process and generate responses to user inputs; a retrieval augmented generation (RAG) module configured to enhance the language model's response generation by retrieving relevant information from a knowledge base; a semantic caching mechanism configured to summarize and store key aspects of interactions for future reference by the language model; an autonomous agent configured to manage and direct user interactions based on processed inputs and generated responses; and a human in the loop interface configured to allow human intervention in the autonomous agent's processing of user interactions when necessary.
22. The autonomous communication system of aspect 21, wherein the language model is further configured to utilize chain of thought reasoning to improve the processing of complex user inputs.
23. The autonomous communication system of any of aspects 21-22, wherein the retrieval augmented generation (RAG) module is further configured to utilize external APIs or tools as part of its information retrieval process to enhance response accuracy.
24. The autonomous communication system of any of aspects 21-23, wherein the semantic caching mechanism is further configured to employ a vector database for efficient storage and retrieval of interaction summaries.
25. The autonomous communication system of any of aspects 21-24, wherein the autonomous agent is further configured to selectively engage additional specialized agents based on the context of the user interaction, each specialized agent being trained for specific interaction types.
26. The autonomous communication system of any of aspects 21-25, wherein the human in the loop interface is further configured to provide feedback mechanisms for human operators to refine the responses generated by the language model and to update the knowledge base used by the retrieval augmented generation (RAG) module.
27. The autonomous communication system of any of aspects 21-26, wherein the autonomous agent is further configured to utilize a framework for combining external knowledge with the language model to enhance reasoning capabilities during user interactions.
28. A computer-implemented method for managing autonomous communication, the method comprising: processing user inputs using a language model; enhancing response generation to the user inputs by retrieving relevant information from a knowledge base using a retrieval augmented generation (RAG) module; summarizing and storing key aspects of interactions using a semantic caching mechanism for future reference by the language model; managing and directing user interactions based on the processed inputs and generated responses through an autonomous agent; and allowing human intervention in the processing of user interactions when necessary via a human in the loop interface.
29. The method of aspect 28, further comprising utilizing chain of thought reasoning by the language model to improve the processing of complex user inputs.
30. The method of any of aspects 28-29, further comprising utilizing external APIs or tools as part of the information retrieval process by the retrieval augmented generation (RAG) module to enhance response accuracy.
31. The method of any of aspects 28-30, further comprising employing a vector database by the semantic caching mechanism for efficient storage and retrieval of interaction summaries.
32. The method of any of aspects 28-31, further comprising selectively engaging additional specialized agents based on the context of the user interaction by the autonomous agent, each specialized agent being trained for specific interaction types.
33. The method of any of aspects 28-32, further comprising providing feedback mechanisms for human operators to refine the responses generated by the language model and to update the knowledge base used by the retrieval augmented generation (RAG) module via the human in the loop interface.
34. The method of any of aspects 28-33, further comprising utilizing a framework by the autonomous agent for combining external knowledge with the language model to enhance reasoning capabilities during user interactions.
35. A computer-readable medium having stored thereon instructions that when executed cause a computer to: process user inputs using a language model; enhance response generation to the user inputs by retrieving relevant information from a knowledge base using a retrieval augmented generation (RAG) module; summarize and store key aspects of interactions using a semantic caching mechanism for future reference by the language model; manage and direct user interactions based on processed inputs and generated responses through an autonomous agent; and allow for human intervention in the processing of user interactions when necessary via a human in the loop interface.
36. The computer-readable medium of aspect 35, wherein the instructions further cause the computer to utilize chain of thought reasoning within the language model to improve the processing of complex user inputs.
37. The computer-readable medium of any of aspects 35-36, wherein the instructions further cause the computer to utilize external APIs or tools as part of the information retrieval process of the retrieval augmented generation (RAG) module to enhance response accuracy.
38. The computer-readable medium of any of aspects 35-37, wherein the instructions further cause the computer to employ a vector database within the semantic caching mechanism for efficient storage and retrieval of interaction summaries.
39. The computer-readable medium of any of aspects 35-38, wherein the instructions further cause the computer to selectively engage additional specialized agents based on the context of the user interaction through the autonomous agent, each specialized agent being trained for specific interaction types.
40. The computer-readable medium of any of aspects 35-39, wherein the instructions further cause the computer to provide feedback mechanisms for human operators to refine the responses generated by the language model and to update the knowledge base used by the retrieval augmented generation (RAG) module via the human in the loop interface.
41. The computer-readable medium of any of aspects 35-40, wherein the instructions further cause the computer to utilize a framework for combining external knowledge with the language model through the autonomous agent to enhance reasoning capabilities during user interactions.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An autonomous communication system comprising:
a language model configured to process and generate responses to user inputs;
a retrieval augmented generation (RAG) module configured to enhance the language model's response generation by retrieving relevant information from a knowledge base;
a semantic caching mechanism configured to summarize and store key aspects of interactions for future reference by the language model;
an autonomous agent configured to manage and direct user interactions based on processed inputs and generated responses; and
a human in the loop interface configured to allow human intervention in the autonomous agent's processing of user interactions when necessary.

2. The autonomous communication system of claim 1, wherein the language model is further configured to utilize chain of thought reasoning to improve the processing of complex user inputs.

3. The autonomous communication system of claim 1, wherein the retrieval augmented generation (RAG) module is further configured to utilize external APIs or tools as part of its information retrieval process to enhance response accuracy.

4. The autonomous communication system of claim 1, wherein the semantic caching mechanism is further configured to employ a vector database for efficient storage and retrieval of interaction summaries.

5. The autonomous communication system of claim 1, wherein the autonomous agent is further configured to selectively engage additional specialized agents based on the context of the user interaction, each specialized agent being trained for specific interaction types.

6. The autonomous communication system of claim 1, wherein the human in the loop interface is further configured to provide feedback mechanisms for human operators to refine the responses generated by the language model and to update the knowledge base used by the retrieval augmented generation (RAG) module.

7. The autonomous communication system of claim 1, wherein the autonomous agent is further configured to utilize a framework for combining external knowledge with the language model to enhance reasoning capabilities during user interactions.

8. A computer-implemented method for managing autonomous communication, the method comprising:
processing user inputs using a language model;
enhancing response generation to the user inputs by retrieving relevant information from a knowledge base using a retrieval augmented generation (RAG) module;
summarizing and storing key aspects of interactions using a semantic caching mechanism for future reference by the language model;
managing and directing user interactions based on the processed inputs and generated responses through an autonomous agent; and
allowing human intervention in the processing of user interactions when necessary via a human in the loop interface.

9. The method of claim 8, further comprising utilizing chain of thought reasoning by the language model to improve the processing of complex user inputs.

10. The method of claim 8, further comprising utilizing external APIs or tools as part of the information retrieval process by the retrieval augmented generation (RAG) module to enhance response accuracy.

11. The method of claim 8, further comprising employing a vector database by the semantic caching mechanism for efficient storage and retrieval of interaction summaries.

12. The method of claim 8, further comprising selectively engaging additional specialized agents based on the context of the user interaction by the autonomous agent, each specialized agent being trained for specific interaction types.

13. The method of claim 8, further comprising providing feedback mechanisms for human operators to refine the responses generated by the language model and to update the knowledge base used by the retrieval augmented generation (RAG) module via the human in the loop interface.

14. The method of claim 8, further comprising utilizing a framework by the autonomous agent for combining external knowledge with the language model to enhance reasoning capabilities during user interactions.

15. A computer-readable medium having stored thereon instructions that when executed cause a computer to:
process user inputs using a language model;
enhance response generation to the user inputs by retrieving relevant information from a knowledge base using a retrieval augmented generation (RAG) module;
summarize and store key aspects of interactions using a semantic caching mechanism for future reference by the language model;
manage and direct user interactions based on processed inputs and generated responses through an autonomous agent; and
allow for human intervention in the processing of user interactions when necessary via a human in the loop interface.

16. The computer-readable medium of claim 15, wherein the instructions further cause the computer to utilize chain of thought reasoning within the language model to improve the processing of complex user inputs.

17. The computer-readable medium of claim 15, wherein the instructions further cause the computer to utilize external APIs or tools as part of the information retrieval process of the retrieval augmented generation (RAG) module to enhance response accuracy.

18. The computer-readable medium of claim 15, wherein the instructions further cause the computer to employ a vector database within the semantic caching mechanism for efficient storage and retrieval of interaction summaries.

19. The computer-readable medium of claim 15, wherein the instructions further cause the computer to selectively engage additional specialized agents based on the context of the user interaction through the autonomous agent, each specialized agent being trained for specific interaction types.

20. The computer-readable medium of claim 15, wherein the instructions further cause the computer to provide feedback mechanisms for human operators to refine the responses generated by the language model and to update the knowledge base used by the retrieval augmented generation (RAG) module via the human in the loop interface.

21. The computer-readable medium of claim 15, wherein the instructions further cause the computer to utilize a framework for combining external knowledge with the language model through the autonomous agent to enhance reasoning capabilities during user interactions.
